(19) United States
(12) Patent Application Publication
(10) Pub. No.: US 2021/0073685 A1
(43) Pub. Date: Mar. 11, 2021

(54) SYSTEMS AND METHODS INVOLVING DETECTION OF COMPROMISED DEVICES THROUGH COMPARISON OF MACHINE LEARNING MODELS

(71) Applicant: NXP B.V., Eindhoven (NL)

(72) Inventors: Nikita Veshchikov, Brussels (BE); Joppe Willem Bos, Wijgmaal (BE)

(21) Appl. No.: 16/564,639

(22) Filed: Sep. 9, 2019

(51) Int. Cl. G06N 20/10; G06F 21/56; G06N 20/20; G06F 16/903

(52) U.S. Cl. CPC G06N 20/10; G06F 16/903; G06N 20/20; G06F 21/56

(57) ABSTRACT

A detection of compromised devices through comparison of machine learning models is provided, according to certain aspects, by a data-aggregation circuit, and a computer server. The data-aggregation circuit is used to assimilate respective sets of output data from at least one of a plurality of circuits to create a new data set, the respective sets of output data being related in that each set of output data is in response to a common data set processed by the machine learning circuitry in the at least one of the plurality of circuits. The computer server uses the new data set to indicate whether one of the machine-learning circuitries may be compromised.

### OVERVIEW

Aspects of various embodiments are directed to systems and methods involving detection of compromised devices through comparison of machine learning models.

Machine learning (ML) is a field of computer science and mathematics. Machine learning allows an extraction of patterns from structured as well as unstructured datasets (e.g., databases). A machine learning model, or simply a model, allows one to extract such patterns. In the domain of machine learning, creation of a model is referred to as training. When a machine learning model is trained using a dataset that contains errors, it is often referred to as being poisoned. A machine learning model may be used to make predictions about new data that was never used during the training, such as, e.g., predicting the temperature or stock prices as well as image classification and voice recognition. Such use of a trained machine learning model for making predictions is called inference.

Many domains may rely on machine learning to detect abnormal behavior of software, hardware or of any part of an environment, for example. However, it can be difficult to detect an anomaly in a new platform, for example, if it has not been previously launched. One may assume that a newly created platform (such as, e.g., a machine learning model) or a device may not be at fault, which may not be correct.

These and other matters have presented challenges to detect whether a machine learning model built by an embedded device is good, for a variety of applications.

### SUMMARY

Various example embodiments are directed to issues such as those addressed above and/or others which may become apparent from the following disclosure concerning detection of compromised devices or platforms through comparison of machine learning models.

In certain example embodiments, aspects of the present disclosure involve detection of whether a machine learning model built or trained by an embedded device was not compromised or poisoned by bad data (in other words, based on errors).

In a more specific example embodiment, detection of compromised devices through comparison of machine learning models may be provided by a data-aggregation circuit, and a computer server. The data-aggregation circuit may be used to assimilate respective sets of output data from each of a plurality of circuits having respective machine-learning circuitries, the respective sets of output data being related in that each set of output data is in response to a common data set processed by the machine-learning circuitry in each of the plurality of circuits. The computer server may use the new data set to indicate whether one of the machine-learning circuitries may be compromised.

In another specific example embodiment, detection of compromised devices through comparison of machine learning models may be provided by one or more of a plurality of circuits, a data-aggregation circuit, and a computer. The one or more of a plurality of circuits may each have machine-learning circuitry embedded therein. The data-aggregation circuit may be used to assimilate respective sets of output data from each of a plurality of circuits, the respective sets of output data being related in that each set of output data is in response to a common data set processed by the machine-learning circuitry in each of the plurality of circuits. The computer server may use the new data set to assess whether trained machine-learning operations in at least one of the plurality of circuits may be compromised.

In other specific example embodiments, a method of detecting compromised devices through comparison of machine learning models may be provided by: querying each of a plurality of circuits, each including machine-learning circuitry, with data sets to prompt respective sets of output data from each of the plurality of circuits; assimilating the respective sets of output data to create a new data set; and using the new data set to assess whether machine-learning operations in at least one of the plurality of circuits may be compromised.

The above discussion/summary is not intended to describe each embodiment or every implementation of the present disclosure. The figures and detailed description that follow also exemplify various embodiments.

### BRIEF DESCRIPTION OF FIGURES

Various example embodiments may be more completely understood in consideration of the following detailed description in connection with the accompanying drawings, in which:

FIG. 1 is a block diagram illustrating an example system of detecting compromised devices through comparison of machine learning models, in accordance with the present disclosure; and

FIG. 2 is a block diagram illustrating an example system of detecting compromised devices through comparison of machine learning models, in accordance with the present disclosure.

While various embodiments discussed herein are amenable to modifications and alternative forms, aspects thereof have been shown by way of example in the drawings and will be described in detail. It should be understood, however, that the intention is not to limit the disclosure to the particular embodiments described. On the contrary, the intention is to cover all modifications, equivalents, and alternatives falling within the scope of the disclosure including aspects defined in the claims. In addition, the term “example” as used throughout this disclosure is only by way of illustration, and not limitation.

### DETAILED DESCRIPTION

Aspects of the present disclosure are believed to be applicable to a variety of different types of apparatuses, systems and methods involving detection of compromised platforms or devices. In certain implementations, aspects of the present disclosure have been shown to be beneficial when used in the context of machine learning devices such as intelligent logic (e.g., computer and application-specific circuits) circuitry used in vehicular and industrial applications and in connection with machine learning in the Internet of Things (IoT). As other related examples, aspects herein may be particularly beneficial when used in connection with such circuitry configured to assure integrity of the operation of equipment and other circuitry (whether or not the other circuitry employs machine learning). While not necessarily so limited, various aspects may be appreciated through the following discussion of non-limiting examples which use exemplary contexts.

Accordingly, in the following description various specific details are set forth to describe specific examples presented herein. It should be apparent to one skilled in the art, however, that one or more other examples and/or variations of these examples may be practiced without all the specific details given below. In other instances, well known features have not been described in detail so as not to obscure the description of the examples herein. For ease of illustration, the same reference numerals may be used in different diagrams to refer to the same elements or additional instances of the same element. Also, although aspects and features may in some cases be described in individual figures, it will be appreciated that features from one figure or embodiment can be combined with features of another figure or embodiment even though the combination is not explicitly shown or explicitly described as a combination.

Embodiments as characterized herein may be implemented in accordance with a variety of different types of systems and methods in which different machine learning models used in respective logic/CPU-based devices (e.g., IoT circuits or devices) may be assessed or compared and in response, an anomaly in one or more of the devices may be detected. The different machine learning models used in the respective logic/CPU-based devices may be of the same type or they may be entirely disparate types of machine learning models. As an example consistent with either situation, data sets may be collected from the different machine learning models in order to assess and/or compare the machine learning models' behavior relative to the behavior of one or more of the logic/CPU-based devices in order to detect whether one of the machine learning models may be compromised in some way, such as operating generally in a faulty (or poisoned due to a virus/malware) manner and/or compromised in some other way. Data sets may be collected, for example, by readings from sensors, on the devices for the purpose of anomaly detection. Such anomalies include, for example, software malfunctions or failures, cyber-attacks on a system, manufacturing defects on monitored, or produced, parts, hardware malfunctions or failures, a bug in code used to configure a logic circuit in said one of the machine-learning circuitries; a hardware circuit indicating an improper calibration, etc. Each device can run applications and may send a message to a central computer server in case an anomaly is detected.

According to one particular example, the logic/CPU-based devices may be involved in or part of a malware detection system that employs machine learning. In a computer or a server system coupled to the logic/CPU-based devices, a machine learning algorithm may try to detect malware by analyzing a state of the device while the device is operating (e.g., executing programs). The devices may be turned on at different moments in time and thus may collect data and train their machine learning models separately and independently of each other. The devices may, however, be scheduled to send their machine learning models (that they trained) at some fixed moment in time to the computer server so that the server can compare them. The system may indicate that machine-learning circuitry in the system may have been impacted by malware.

For assessing/the data sets corresponding to the different machine learning models, a computer (server) may use a data aggregation circuit, for example, to reconstruct a representation of the different machine learning algorithms from separate devices for comparison purposes, such as to identify devices including anomalies (e.g., in hardware or software). The server/aggregator may look for outliers of the machine learning models from the devices that do not resemble the reconstructed machine learning model, or the other machine learning models of the separate devices. An assumption may be made that most of the devices will not be compromised, and that machine learning models from compromised devices will behave differently. Once outliers are identified, distance between the models (i.e., how similar or how different they are) may be measured in order to determine a degree of similarity or dissimilarity between different models or between a device's model and the reconstructed model, for example. Measuring the distance between models may further assist in a determination of whether or not a device or platform may be compromised.

According to one example, a system-wide machine learning comparison to detect an anomaly, involving such reconstruction, may be aligned with the following steps. At the outset, different models from or corresponding to the respective machine learning-based (e.g., IoT) devices are transferred to the cloud/server. Next, simulated replication is carried out by a computer circuit by first labeling a large amount of working data using some or all of the transferred models. This working data may be random input, non-problem-domain data or problem domain data. Once reconstructed, the computer circuit uses the labeled working data to detect any anomalies in machine learning models created by separate (IoT) devices. The new, reconstructed model now has the merged behavior of all transferred models, and the individual models from the separate (IoT) devices may be compared to the reconstructed model to see if the model created by each device is an outlier, for example. Being an outlier may indicate that the device may include an anomaly. Also, the distance of an outlier from the reconstructed model may be calculated in order to detect anomalies, or poisoned software or hardware; for example, in a device.

The above and other examples in accordance with the present disclosure are directed to systems and methods of detection of compromised devices through comparison of machine learning models of the devices, and may be provided by a data-aggregation circuit, and a computer server. The data-aggregation circuit may be used to assimilate respective sets of output data from each of a plurality of circuits having respective machine-learning circuitries, the respective sets of output data being related in that each set of output data is in response to a common data set processed by the machine-learning circuitry in each of the plurality of circuits. The computer server may use the new data set to indicate whether one of the machine-learning circuitries may be compromised.

In other embodiments, the system, for example, may include one or more of a plurality of circuits, a data-aggregation circuit, and a computer. The one or more of a plurality of circuits may each have machine-learning circuitry embedded therein. The data-aggregation circuit may be used to assimilate respective sets of output data from each of a plurality of circuits, the respective sets of output data being related in that each set of output data is in response to a common data set processed by the machine-learning circuitry in each of the plurality of circuits. The computer server may use the new data set to assess whether trained machine-learning operations in at least one of the plurality of circuits are compromised.

Other embodiments are directed to methods detecting compromised devices through comparison of machine learning models. The methods may be provided by: querying each of a plurality of circuits, each including machine-learning circuitry, with data sets to prompt respective sets of output data from each of the plurality of circuits; assimilating the respective sets of output data to create a new data set; and using the new data set to assess whether machine-learning operations in at least one of the plurality of circuits may be compromised. Alternatively or additionally, the machine-learning circuitries may provide an output related to a prediction or alarm of a manufacturing process defect, for example.

In some embodiments, the computer server may use the new data set to provide initial machine-learning operations in at least one of the plurality of circuits' machine-learning circuitry, or in at least multiple ones of the plurality of circuits. Alternatively or additionally, the computer server may use the new data set to retrain at least one of the plurality of circuits' machine-learning circuitry, after at least one of the plurality of circuits has evolved with machine-learning operations based on other input data.

In some embodiments, the computer server and the data-aggregation circuit may be part of a computer circuit configured to use the machine-learning circuitry, after being trained by the server, to predict a parameter related to an industrial manufacturing process.

In some embodiments, the computer server may be used to detect whether said one of the machine-learning circuitries may have a malfunction or be faulty. The data-aggregation circuit may combine the respective sets of output data by using a voting scheme through which at least one of the respective sets of output data is adversely weighted relative to other ones of the respective sets of output data to be combined, determined to be an outlier. The computer server may detect whether one of the machine-learning circuitries may have a malfunction corresponding to, for example: a hardware circuit malfunction; a bug in code used to configure a logic circuit in said one of the machine-learning circuitries; and a hardware circuit indicating an improper calibration.

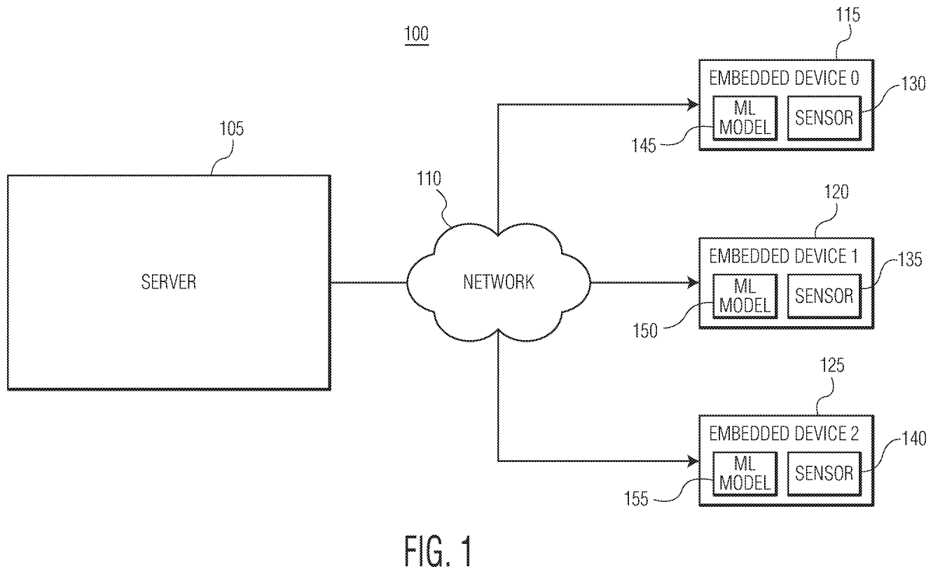

Turning now to the figures, FIG. 1 is a block diagram of an example system of comparing machine learning models 100 in order to identify compromised devices and/or models, in accordance with the present disclosure. As shown, the system 100 includes a computer server 105 that may communicate with a plurality of devices 115, 120, 125, such as, for example, IoT devices, which can run applications and can communicate with the server 105. The server 105 may include or integrate circuitry that allows the aggregation or collection of machine learning models from the plurality of separate devices. Optionally, data-aggregation circuitry may be a separate component from the server 105. The system 100 also includes the plurality of circuits, or devices. Three such circuits or devices 115, 120, 125 are shown, which can communicate through a network 110, but other numbers of circuits are also contemplated. Each of the plurality of circuits 115, 120, 125, or embedded devices, are shown including a sensor 130, 135, 140, and a machine learning model 145, 150, 155, respectively.

In the example embodiment of FIG. 1, the machine learning models 145, 150, 155 may be uploaded by the system 100 to each of the plurality of devices 115, 120, 125 or may be created or trained by each device itself. For example, during initialization of the system 100, devices 115, 120, 125 may start collecting data through sensors 130, 135, 140. Once sufficient data is collected, each device 115, 120, 125 may train the machine learning model 145, 150, 155, respectively. As discussed above, alternatively, the system 100 may include uploaded, initial machine learning models in each device 115, 120, 125 that may be updated by the system 100.

An advantage of using a single machine learning model that is prepared in advance and uploaded to the plurality of devices is that there is a smaller computational load on each device. Also, the single machine learning model may be tested in advance to check for possible problems. On the other hand, an advantage of using machine learning models that are created by each of the plurality of circuits is that there is no need to collect data, train a model, and upload it to each device. Also, the model may be tuned to a specific combination of device, sensor and external conditions.

If one of a plurality of circuits, such as 115, 120, 125 in FIG. 1, is turned on for a first time, it may not have a machine learning model yet. For instance, to build a machine learning model, the device will collect data (that may be needed for training as well as inference), and will build a model of its normal behavior while supposing that its current behavior is indeed normal. This assumes that a new device that has not been used before is not faulty. This may be the case most of the time with few exceptions. The method described herein, however, may also detect if a new device is faulty.

In some embodiments, such as that shown in FIG. 1, the computer server 105 may cause each of the plurality of circuits 115, 120, 125 to be queried with the common data set and, in response, cause each of the plurality of circuits 115, 120, 125 to generate or derive an associated one of the respective sets of output data. Each of the plurality of circuits 115, 120, 125 may include an Internet of Things (IoT) circuit, for example.

In some embodiments, the machine learning circuitry in one of the plurality of circuits 115, 120, 125 may be different from another of the plurality of circuits 115, 120, 125. Additionally or alternatively, the respective machine learning circuitries may be programmed with different machine learning algorithms and/or may, for example, be programmed with one of the following different types of machine learning algorithms: support vector learning, neural network learning, and random forest learning. Additionally or alternatively, at least one of the plurality of circuits may be an IoT (Internet of Things) circuit having an embedded machine-learning algorithm.

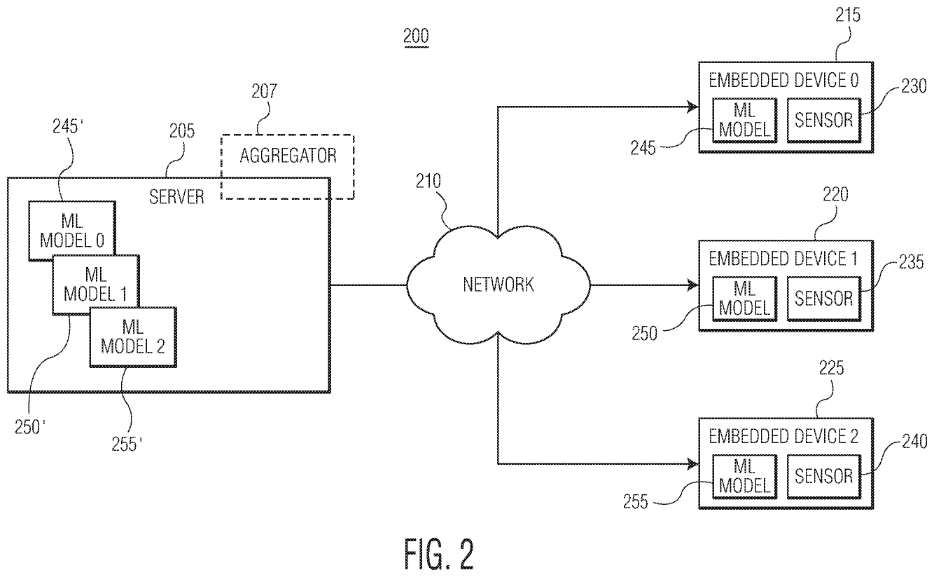

FIG. 2 is a block diagram of an example system 200 of comparing machine learning models in order to identify compromised devices and/or models, in accordance with the present disclosure. The system 200, for example, shows the state of system 100 from FIG. 1 after the devices have sent their machine learning models to the server. As shown, the system 200 includes a computer server 205 that may communicate with a plurality of devices 215, 220, 225, such as, for example, IoT devices, which can run applications and can communicate with the server 205. The server 205 may include or integrate circuitry that allows the aggregation or collection of machine learning models from the plurality of separate devices. Optionally, data-aggregation circuitry may be a separate component, indicated in FIG. 2 as aggregator 207, from the server 205. The system 200 also includes the plurality of circuits, or devices. Three such circuits or devices 215, 220, 225 are shown, which can communicate through a network 210, but other numbers of circuits are also contemplated. Each of the plurality of circuits 215, 220, 225, or embedded devices, are shown including a sensor 230, 235, 240, and a machine learning model 245, 250, 255, respectively. The outputs from the machine learning models 245, 250, 255, that are collected in server 205 and/or aggregator 207 are indicated in FIG. 2 as machine learning model 0 245′, machine learning model 1 250′, and machine learning model 2 255′.

In examples disclosed herein, the data-aggregation circuit, or data-aggregator device 207, may be implemented by a computer server. However, any other type of computing platform may additionally or alternatively be used such as, for example, a desktop computer, a laptop computer, etc.

In examples disclosed herein, the network is a public network such as, for example, the Internet. However, any other network may be used. For example, some or all of the network may be a company's intranet network (e.g. a private network), a user's home network, a public network (e.g., at a coffee shop), etc.

The methods and techniques of combining and/or comparing machine learning models described herein can be applied to a variety of systems, situations, and set-ups. The content of the disclosure is not limited to the systems described and shown herein.

In some example embodiments, once the server receives machine learning models from the devices, the server may start a model comparison procedure or method. There may be multiple ways of performing such comparisons of machine learning models. Generally, the procedures find outliers among the models. An outlier is an object (a machine learning model, in this case) that does not resemble all other objects of the same type. An assumption is made that most of the devices will not be compromised (or faulty) and the models from compromised devices will look and behave differently. A model that is far away from all other models would be an outlier, for example. The different comparison methods may be used to measure the distance between two models.

One example approach to measuring the distance between two machine learning models may be based on success rate. Given two models, M₀ and M₁, the server can prepare a dataset (simulated or real data) and submit it to both models. The results produced by both models may tell whether the input is considered normal or an anomaly. In order to then compare the two models, the success rate (SR) may be computed using the formula:

SR=(#correct answers)/(#total answers) (1)

for M₀ and M₁. The distance (D) may be calculated by the following equation:

D=abs(SR(M₁)−SR(M₀)) (2)

where abs is the absolute value and SR is the success rate for a given model. If the distance is close to 0, it means that the models are similar, but if the distance is close to 1, then it means that the models are different in behavior.

Another example approach to computing the distance between two machine learning models may be based on prediction and may be done by comparing outputs for every single query. If there are two models, M₀ and M₁, each model may output only two answers, which are normal or an anomaly. When comparing the models, there can be only two outcomes, which is that the two models agree and output the same answer or that they disagree and output different answers. The distance between the two models can be computed using the following formula:

D=(#identical answers)/(#total queries) (3)

For models that can potentially produce more than two different answers, the prediction method may be slightly modified by instead comparing the rankings of answers produced by the two models. Instead of comparing outcomes directly, it may be possible to compare the rankings of the outcomes. When a model gives a prediction, it usually outputs a vector of probabilities such as, e.g., “normal: 0.1, abnormal: 0.9.” In such an example, there is a 90% chance that the submitted data is abnormal and a 10% chance that it is normal. Distance between the two models can be based on comparison of these vectors between the two models for each query in the data set that is used by the server to compare the models. The same approach may also be valid for models that can produce more than two different predictions.

The above and other aspects of the instant disclosure relate to and may be combined with features and aspects concerning data aggregation and/model (re)training generally and with regards to configuration, structure, steps and uses, as described and illustrated by way of examples in concurrently-filed U.S. patent application Ser. No. ______ (Docket No. 82159589US01/NXPS.1500PA, by the same inventors and having the same assignee), the disclosure of which is incorporated by reference in its entirety generally and with regards to the above-mentioned features and aspects specifically.

The skilled artisan would recognize that various terminology as used in the Specification (including claims) connote a plain meaning in the art unless otherwise indicated. As examples, the Specification describes and/or illustrates aspects useful for implementing the claimed disclosure by way of various circuits or circuitry which may be illustrated as or using terms such as blocks, modules, device, system, and/or other circuit-type depictions. Such circuits or circuitry are used together with other elements to exemplify how certain embodiments may be carried out in the form or structures, steps, functions, operations, activities, etc. For example, in certain of the above-discussed embodiments, one or more modules are discrete logic circuits or programmable logic circuits configured and arranged for implementing these operations/activities, as may be carried out in the approaches shown in FIGS. 1 and 2. In certain embodiments, such a programmable circuit is one or more computer circuits, including memory circuitry for storing and accessing a program to be executed as a set (or sets) of instructions (and/or to be used as configuration data to define how the programmable circuit is to perform), and an algorithm or process is used by the programmable circuit to perform the related steps, functions, operations, activities, etc. Depending on the application, the instructions (and/or configuration data) can be configured for implementation in logic circuitry, with the instructions (whether characterized in the form of object code, firmware or software) stored in and accessible from a memory (circuit). As another example, where the Specification may make reference to a “first [type of structure]”, a “second [type of structure]”, etc., where the [type of structure] might be replaced with terms such as [“circuit”, “circuitry” and others], the adjectives “first” and “second” are not used to connote any description of the structure or to provide any substantive meaning; rather, such adjectives are merely used for English-language antecedence to differentiate one such similarly-named structure from another similarly-named structure (e.g., “first circuit configured to convert . . . ” is interpreted as “circuit configured to convert . . . ”).

Based upon the above discussion and illustrations, those skilled in the art will readily recognize that various modifications and changes may be made to the various embodiments without strictly following the exemplary embodiments and applications illustrated and described herein. For example, methods as exemplified in the Figures may involve steps carried out in various orders, with one or more aspects of the embodiments herein retained, or may involve fewer or more steps. Such modifications do not depart from the true spirit and scope of various aspects of the disclosure, including aspects set forth in the claims

What is claimed is:

1. An apparatus comprising:
a data-aggregation circuit to assimilate respective sets of output data from each of a plurality of circuits having respective machine-learning circuitries, the respective sets of output data being related in that each set of output data is in response to a common data set processed by the machine-learning circuitry in each of the plurality of circuits; and
a computer server to use the new data set to indicate whether one of the machine-learning circuitries may be compromised.

2. The apparatus of claim 1, wherein the computer server is used to detect whether said one of the machine-learning circuitries may have a malfunction, and wherein the data-aggregation circuit is to combine the respective sets of output data by using a voting scheme through which at least one of the respective sets of output data is adversely weighted relative to other ones of the respective sets of output data to be combined, determined to be an outlier.

3. The apparatus of claim 1, wherein the data-aggregation circuit is to combine the respective sets of output data by using a voting scheme through which at least one of the respective sets of output data is determined to be an outlier, and wherein the computer server is detect whether said one of the machine-learning circuitries may have a malfunction corresponding to: a hardware circuit malfunction; a bug in code used to configure a logic circuit in said one of the machine-learning circuitries; and a hardware circuit indicating an improper calibration.

4. The apparatus of claim 1, wherein the computer server to use the new data set to provide initial machine-learning operations in at least one of the plurality of circuits machine-learning circuitry.

5. The apparatus of claim 1, wherein the computer server to use the new data set to retrain at least one of the plurality of circuits machine-learning circuitry, after at least one of the plurality of circuits has evolved with machine-learning operations based on other input data.

6. The apparatus of claim 1, wherein the computer server is to use the new data set to train machine-learning operations in at least multiple ones of the plurality of circuits.

7. The apparatus of claim 1, wherein the computer server to use the new data set to indicate that one of the machine-learning circuitries may have been impacted by malware.

8. The apparatus of claim 1, wherein the computer server and the data-aggregation circuit are part of a computer circuit configured to use the machine-learning circuitry, after being trained by the server, to predict a parameter related to an industrial manufacturing process.

9. The apparatus of claim 1, wherein the computer server and the data-aggregation circuit are part of a computer circuit configured to maintain integrity in the machine-learning circuitry of each of the plurality of circuits.

10. The apparatus of claim 1, wherein the computer server and the data-aggregation circuit are part of a computer circuit configured to use the machine-learning circuitries to provide an output related to a prediction or alarm of a manufacturing process defect.

11. An apparatus comprising:
one or more of a plurality of circuits, each having machine-learning circuitry embedded therein;
a data-aggregation circuit to assimilate respective sets of output data from each of a plurality of circuits, the respective sets of output data being related in that each set of output data is in response to a common data set processed by the machine-learning circuitry in each of the plurality of circuits; and
a computer server to use the new data set to assess whether trained machine-learning operations in at least one of the plurality of circuits are compromised.

12. The apparatus of claim 11, wherein the computer server is to cause each of the plurality of circuits to be queried with the common data set and in response, cause each of the plurality of circuits to generate or derive an associated one of the respective sets of output data, and wherein each of the plurality of circuits is or includes an IoT (Internet of Things) circuit.

13. The apparatus of claim 11, wherein the machine-learning circuitry in one of the plurality of circuits is different from another of the plurality of circuits.

14. The apparatus of claim 11, wherein in each of at least two of the plurality of circuits, the respective machine-learning circuitries are programmed with different machine-learning algorithms.

15. The apparatus of claim 11, wherein in each of at least two of the plurality of circuits, the respective machine-learning circuitries are programmed with at least two of the following different types of machine-learning algorithms: support vector learning, neural network learning, and random forest learning.

16. The apparatus of claim 11, wherein at least one of the plurality of circuits is an IoT (Internet of Things) circuit having an embedded machine-learning algorithm.

17. A method comprising:
querying each of a plurality of circuits, each including machine-learning circuitry, with data sets to prompt respective sets of output data from each of the plurality of circuits;
assimilating the respective sets of output data to create a new data set; and
using the new data set to assess whether machine-learning operations in at least one of the plurality of circuits may be compromised.

18. The method of claim 17, further including wherein using the machine-learning circuitries to provide an output related to a prediction or alarm of a manufacturing process defect.

19. The method of claim 17, wherein in one of the plurality of circuits, the respective machine-learning circuitry is configured with a machine-learning support vector learning algorithm.

20. The method of claim 17, wherein in each of the plurality of circuits, the respective machine-learning circuitry is configured with a machine-learning algorithm from among the following: support vector learning, neural network learning, and random forest learning, and in another of the plurality of circuits, the respective machine-learning circuitry is configured with a different machine-learning algorithm.
